(19) United States
(12) Patent Application Publication
(10) Pub. No.: US 2005/0143517 A1
(43) Pub. Date: Jun. 30, 2005

(54) Compositions consisting of cationic polymers comprising amidinium groups and ionic liquids

(75) Inventor: Friedrich Georg Schmidt, Haltern am See (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Creavis Gesellschaft F. Techn. U. Innovation MBH, Marl (DE)

(21) Appl. No.: 10/508,414

(22) PCT Filed: Feb. 19, 2003
(86) PCT No.: PCT/EP03/01652

(30) Foreign Application Priority Data
Apr. 4, 2002 (DE) 102 14 872.4

(51) Int. Cl. C08K 3/00

(52) U.S. Cl. 524/612

(57) ABSTRACT

The invention relates to compositions containing an ionic liquid and a cationic polymer with cyclic non-aromatic units comprising an amidium group. The invention also relates to the use of said compositions.

The present invention relates to compositions which comprise cationic polymers having cyclic nonaromatic units containing an amidinium group and an ionic fluid and to their use.

For some years now, ionic liquids have been the subject of various research studies. In general terms, an ionic liquid is a liquid which consists exclusively of ions. To differentiate them from a classic salt melt which is usually a high-melting, highly viscous and usually very corrosive medium, ionic liquids are liquid at low temperatures (<100° C.) and have a relatively low viscosity. Even though there are some examples of the successful use of high-temperature salt melts as reaction media in preparative applications, the fact that ionic liquids are in a liquid state below 100° C. has for the first time made it possible for them to be used as replacement for conventional organic solvents in chemical processes. Although ionic liquids have been known since 1914, they have been studied intensively as solvents and/or catalysts in organic syntheses only in the last 10 years (review article by K. R. Seddon in J. Chem. Technol. Biotechnol. 1997, 68, 351-356; T. Welton in Chem. Rev. 1999, 99, 2071-2083; J. D. Holbrey, K. R. Seddon in Clean Products and Processes 1 (1999) 223-236; P. Wasserscheid, W. Keim in Angew. Chem. 2000, 112, 3926-3945 and R. Sheldon in Chem. Comm., 2001, 2399-2407).

S. Fischer et al. in ACS Symp. Ser. (1999) 737, 143-150 report on melts of hydrates of inorganic salts, specifically LiI.2H₂O, LiClO₄.3H₂O, NaSCN/KSCN/LiSCN.2H₂O and LiClO₄.3H₂O/Mg(ClO₄)₂, as solvents for cellulose.

Polymer extractions using chloroaluminate salts melted at room temperature form the subject of papers by J. S. Wilkes et al. (Electrochem. Soc. Proceed. (2000) Volume 99-41 (Molten Salts XII), 65). They used 1-ethyl-2-methylimidazolium chloride/aluminum chloride mixtures as ionic liquids and investigated various polymers, including nylon, polyethylene, PVC and butyl rubber.

WO 00/16902 and WO 00/20115 concern specific ionic liquids which are used as a catalyst or as a solvent for catalysts in various organic syntheses.

Both for use as solvent for catalytic reactions and for other applications, it can be advantageous to immobilize the ionic liquid. The advantages of immobilization in catalytic syntheses are the increased ease of separating off, recovering and regenerating the catalyst and decreased product contamination.

Immobilized ionic liquids are known, for example, from EP-A-0 553 009 and U.S. Pat. No. 5,693,585. Both references describe a calcined support which has immobilized on it an ionic liquid comprising aluminum chloride and an alkylated ammonium chloride or imidazolinium chloride. The immobilized ionic liquids are used as catalysts in alkylation reactions.

WO-A-01/32308 describes ionic liquids which are immobilized on a functionalized support which bears or contains a component of the ionic liquid or a precursor of such a component. The ionic liquid can be immobilized via the anion by treating a support with an anion source before the ionic liquid is applied or formed. Alternatively, the ionic liquid can be immobilized by the cation being covalently bound to the support or incorporated in the support. The immobilized ionic liquids are used as catalysts, e.g. for the Friedel-Crafts reaction.

The work of N. Ogata, K. Sanui, M. Rikukawa, S. Yamada and M. Watanabe (Synthetic Metals 69 (1995), pages 521-524, and Mat. Res. Soc. Symp. Proc. volume 293, page 135 ff.) has also been concerned with “immobilized” ionic liquids, specifically new polymer electrolytes which are in the form of ion-conducting polymer complexes and are formed by dissolution of various polycationic salts in ionic liquids (here also referred to as “salt melts”) comprising aluminum chloride. The polycationic salts can be polyammonium, polypyridinium, polysulfonium and/or polyphosphonium salts. A polymer complex comprising a polypyridinium salt as ionic liquid and a pyridinium salt and aluminum chloride were investigated in detail. In this case, the polypyridinium salt instead of the pyridinium salt is the ionic liquid and makes it possible for the polymer complexes to form thin layers as a result of the tremendous increase in the viscosity compared to the pure ionic liquid. The new polymer complexes have a high ionic conductivity and, like other polymer electrolytes, are of interest for use in batteries and displays.

U.S. Pat. No. 6,025,457 discloses polyelectrolytes of the “salt melt type” which comprise a polymer of the salt melt type which is obtained by reaction of an imidazolium derivative bearing a substituent in the 1- and 3-position with at least one organic acid or an organic acid compound having an acid amide or acid imide bond, with at least one component, i.e. said imidazolium derivative or said organic acid compound, being a polymerizable monomer or a polymer. These polyelectrolytes, too, display high ionic conductivity at room temperature and have good chemical properties.

There is further extensive prior art concerning polymer electrolytes of high conductivity which consist of a nonionic polymer in combination with an ionic liquid.

For instance, J. Fuller et al. in J. Electrochem. Soc. (1997), 144(4), L67-L70 describe rubberlike gel electrolytes composed of poly(vinylidene fluoride-hexafluoropropyl) copolymers and ionic liquids based on 1-ethyl-3-methylimidazolium triflate or tetrafluoroborate.

JP-A-10265673 discloses preparing solid polymer electrolytes in the form of ion-conducting films by polymerization of hydroxyethyl methacrylate and ethylene glycol dimethacrylate in the presence of ionic liquids based on 1-butylpyridinium tetrafluoroborate.

JP-A-10265674 discloses compositions of polymers, for example polyacrylonitrile and polyethylene oxide, and ionic liquids. The ionic liquids contain for example LiBF₄ and 1-ethyl-3-methylimidazolium tetrafluoroborate. Reported uses are solid electrolytes, anti-static agents and screens.

Noda et al. in Electrochim. Acta 45 (2000), 1265-1270 report that certain vinyl monomers can be polymerized in situ from 1-ethyl-3-methylimidazolium tetrafluoroborate or 1-butylpyridinium tetrafluoroborate in room temperature liquid salt melts to produce mechanically robust polymer electrolyte films which are transparent and highly conductive.

Fuller et al. (Molten Salt Forum 5-6 (1998), 605-608) studied mixtures of ionic liquids or other imidazolium salts and poly(vinylidene fluoride-hexafluoropropyl) copolymers. These mixtures possess high conductivity, thermal stability and dimensional stability for applications in batteries, fuel cells or capacitors as highly conductive polymer electrolytes.

Watanabe et al. disclose in Solid State Ionics 86-88 (1996), 353-356 that trimethylammonium benzoate, lithium acetate and lithium bis(trifluoromethylsulfonyl)imide salt mixtures which are liquid at temperatures below 100° C. are compatible with polyacrylonitrile and polyvinyl butyral to produce systems from which film-forming polymer electrolytes can be produced.

The disadvantage with the mixtures of nonionic polymer and ionic liquid is the low ion density.

It is an object of the present invention to provide a novel polymer composition possessing inter alia high ion density, i.e. good conductivity, combined with an adjustable glass transition temperature and coupled with ease of processing and manufacture.

It has now been found that this object is achieved, surprisingly, by a composition comprising a cationic polymer having cyclic nonaromatic units containing an amidinium group and an ionic liquid.

The cyclic nonaromatic units of the cationic polymer which contain an amidinium group can be located in the main chain of the polymer, in the side chains of the polymer or both in the main chain and in the side chains.

The cyclic nonaromatic units which contain an amidinium group are preferably substituted or unsubstituted 5-, 6- or 7-membered rings, particularly preferably substituted or unsubstituted imidazolinium, tetrahydropyrimidinium and tetrahydro-1,3-diazepinium groups, with imidazolinium and tetrahydropyrimidinium groups being most preferred. The cyclic nonaromatic units can also be 8-membered or larger rings.

In a preferred embodiment of the invention, the cyclic nonaromatic units of the cationic polymer which contain an amidinium group are located in the main chain of the polymer. They can then be linked to the main chain via C or N atoms of the cyclic unit. The cyclic nonaromatic units which contain an amidinium group are preferably linked to the main chain of the polymer via the two N atoms. A particularly advantageous cationic polymer is one having the following structural unit in the main chain: 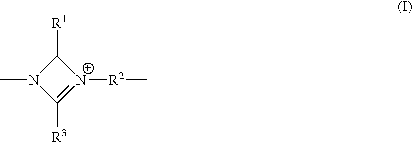
where R¹ is —(CH₂)ₙ— where n=2, 3 or 4, preferably 2 or 3; R² is —(CH₂)ₘ— where 0<m<22, —CH═CH—CH₂—, —CH═CH—CH₂—CH₂—, —CH═CH—, —CH═CH—CH═CH—, a monocyclic or polycyclic arylene radical or a divalent polyether radical of the structure —(CH₂)ₖ—(O—(CH₂)ₖ)ₚ— where 0<k<22 and 0<p<100, in particular R²═R¹; and R³ is —(CH₂)₁—CH₃ where 0<1<21 or a monocyclic or polycyclic aryl radical.

Particular preference is given to n being 2, i.e. the cyclic nonaromatic units which contain an amidinium group are preferably imidazolinium groups.

Alternatively, the cyclic nonaromatic units which contain an amidinium group may be present in the side chains of the polymer. The type of polymer, i.e. the structure of the main chain, is in this case not relevant for the purposes of the invention. Illustrative examples of polymer skeletons having side chains in which the cyclic nonaromatic units which contain an amidinium group are present are vinyl polymers, especially polyacrylates, polyglycosides, polyorganosiloxanes, polyethers, polyesters, polyamides and polyurethanes. The main chain can naturally also be made up of a variety of structural units, so that the polymer is a corresponding copolymer.

The cyclic nonaromatic units which contain an amidinium group and are located in the side chains of the polymer can, for example, have the following structures: 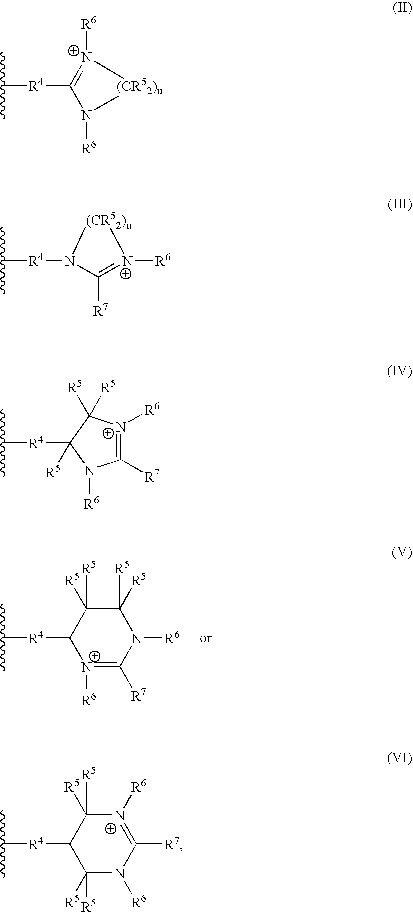
where u=2, 3 or 4, preferably 2 or 3;
R⁴ is selected from among —(CH₂)ᵣ— where 0<r<22, —(CH₂)ₛ—(O—(CH₂)ₛ)ₜ— where 0<s<22 and 0<t<100 and —CO—Y—(CH₂)ᵤ— where Y═O, NH and 1<u<23;
R⁵ is selected from among H, —CH₃—, —C₂H₅, —C₃H₇ and —C₄H₉ and may be identical or different within a unit;
R⁶ is an unbranched or branched alkyl radical having from 1 to 18 carbon atoms and may be identical or different within a unit; and R⁷ is H or R⁶.

Compositions which include cationic polymers which comprise different cyclic nonaromatic units containing an amidinium group are also encompassed by the present invention.

The weight average molecular weight of the cationic polymer is, in a preferred embodiment, from 500 to 1 500 000, more preferably from 500 to 200 000 and most preferably from 20 000 to 50 000.

The counterion of the cationic polymer can be any anion which does not react with the cationic polymer; mixtures of various anions are also suitable. Examples of suitable anions include halide, i.e. chloride, bromide and iodide, preferably iodide; phosphate; halophosphates, preferably hexafluorophosphate; alkyl phosphates; nitrate; sulfate; hydrogensulfate; alkyl sulfates; aryl sulfates; perfluorinated aryl and alkyl sulfates, preferably octyl sulfate; sulfonate, alkylsulfonates; arylsulfonates; perfluorinated arylsulfonates and alkylsulfonates, preferably triflate; perchlorate; tetrachloroaluminate; tetrafluoroborate; alkyl borates, preferably B(C₂H₅)₃C₆H₁₃; tosylate; saccharinate; alkyl carboxylates and bis(perfluoroalkylsulfonyl)amide anions, preferably the bis(trifluoromethylsulfonyl)amide anion.

The most preferred counterions are iodide, hexafluorophosphate, alkyl sulfates, in particular octyl sulfate, tetrafluoroborate and the bis(trifluoromethylsulfonyl)amide anion.

In a preferred embodiment, the counterion of the cationic polymer can be an anion which is suitable for producing liquid-crystalline states, for example an anion of the formula 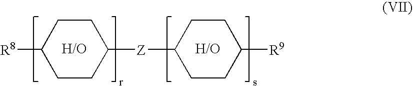
where H/O means that the rings can, independently of one another, be aromatic or saturated;
r and s are each, independently of one another, 0, 1 or 2 and r+s≧2;
z is a single bond, —C₂H₂—, —C₂H₅—, —CF₂O—, —OCF₂—, 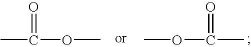
   R⁸ and R⁹ are each, independently of one another, an unsubstituted alkyl radical having up to 15 carbon atoms, an alkyl radical which has up to 15 carbon atoms and is monosubstituted by —CN or CF₃ or is monosubstituted or polysubstituted by halogen, where one or more —CH₂— groups in these radicals may be replaced, independently of one another, by —O—, —S—, —C≡C—, —C—O— 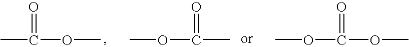
   in such a way that O atoms are not directly bound to one another,
with the proviso that at least one of the radicals R⁸ or R⁹ bears a functional group —COO⁻ or —SO₃⁻, e.g.:

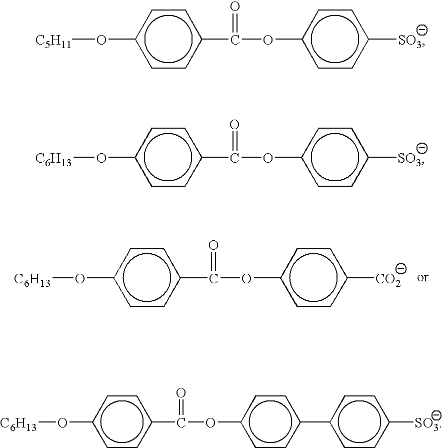

Liquid-crystalline polymers are obtained in this way.

A preferred anion capable of forming liquid crystal phases has the following formula: 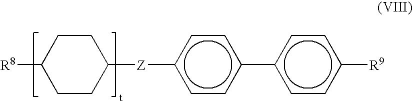
where t=1 or 2 and R⁸, R⁹ are z are as defined above, e.g.

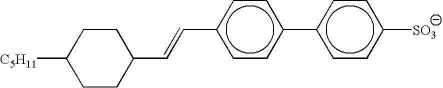

The compositions according to the invention may also include mixtures of various polymers having cyclic nonaromatic units containing an amidinium group or mixtures of one or more polymers having cyclic nonaromatic units containing an amidinium group with another polymer. For example, cationic polymers bearing the cyclic nonaromatic units in the side chains can be mixed with an uncharged polymer which conforms to or resembles the structure of the main chain of the cationic polymer.

The cationic polymers comprising cyclic nonaromatic units which contain an amidinium group can be prepared by various methods. Apart from the use of a monomer which comprises the cyclic nonaromatic units which contain an amidinium group or a nonquaternized amidine group in the polymerization reaction, which leads to polymers having the cationic amidinium groups in the side chains, it is also possible to introduce the cyclic nonaromatic units which contain an amidinium group only after the actual polymerization reaction.

A suitable method of producing imidazolinium, tetrahydropyrimidinium and tetrahydro-1,3-diazepinium rings is, for example, reaction of an ortho ester with the appropriate N,N′-dialkyl-α,ω-alkanediamine in the presence of a suitable ammonium compound, e.g. ammonium tetrafluoroborate or ammonium hexafluorophosphate. The synthesis of the corresponding monomeric cyclic amidinium tetrafluoroborates and hexafluorophosphates has been described by S. Saba, A. Brescia and M. K. Kaloustian in Tetrahedron Letters, volume 32, No. 38, pages 5031-5034 (1991). The cationic polymers of the invention comprising the above-described structural units can be prepared by means of analogous reactions.

To introduce a cyclic amidinium group into a side chain of the polymer, it is possible either to start out from a polymer which bears an ortho ester group, preferably an ethyl ortho ester group, in the side chain and react this with an N,N′-dialkyl-α,ω-alkanediamine, e.g. as in the preparation of a polymer having a side chain of the structure (II) as shown in the following scheme (i) 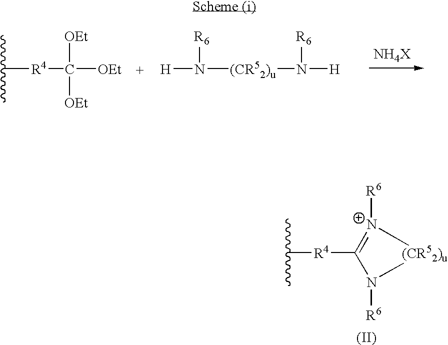
or to start out from a polymer which bears the diamine function in the side chain and react this with an ortho ester, once again preferably an ethyl ortho ester, e.g. as in preparation of a polymer having a side chain of the structure (III) as shown in the following scheme (ii):

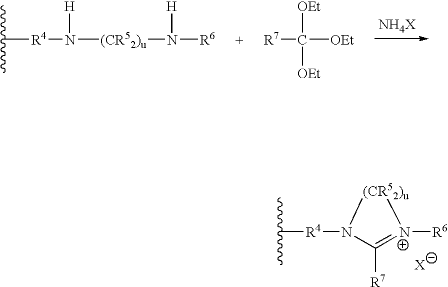

In the two reaction schemes (i) and (ii), R⁴, R⁵, R⁶, R⁷ and u are defined as for the structures (II) and (III); Et is the ethyl radical and X⁻ is a weakly nucleophilic anion, for example tetrafluoroborate or hexafluorophosphate. A person skilled in the art will readily be able to see how polymers having side chains of the structures (IV), (V), (VI) or other structures within the scope of the present invention can be prepared by analogous reactions using appropriately chosen starting compounds.

Polymers having imidazolinium, tetrahydropyrimidinium and tetrahydro-1,3-diazepinium groups in the main chain can also be prepared via the reaction with an ortho ester. Thus, for example, the reaction of linear or predominantly linear polyethylenamine with an ortho ester in accordance with the following scheme (iii) 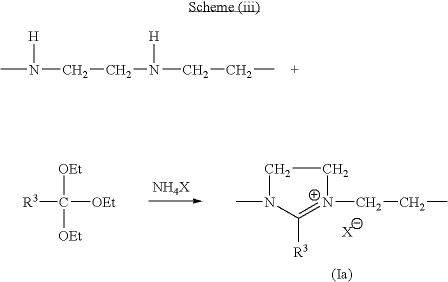
leads to a cationic polymer having imidazolinium groups in the main chain, where Et and X⁻ in the above scheme (iii) are as defined above and the imidazolinium groups are linked to the main chain via N atoms. The structural unit (Ia) produced in this way is a specific example of the more general structural unit (I) described above in which R¹ is —CH₂)ₙ— where n=2 and R² is R¹. In scheme (iii) above, R³ is defined as for the structural unit (I).

If the polyethylenamine used contains long-chain branches analogous to the starting polymer shown in scheme (ii), reaction with an ortho ester in accordance with scheme (ii) and (iii) gives a polymer which has imidazolinium groups both in the main chain and in the side chains.

Polymers in which the cyclic nonaromatic units are located in the main chain and are linked to it via C atoms can likewise be prepared by reaction with an ortho ester. Thus, for example, the reaction of polyvinylamine with an ortho ester, preferably an ethyl ortho ester, as shown in scheme (iv) leads to a cationic polymer having tetrahydropyrimidinium groups in the main chain.

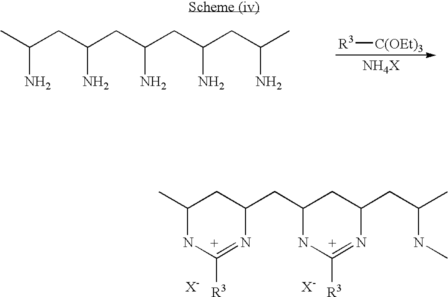

Analogously, the reaction of polyallylamine with an ortho ester, preferably an ethyl ortho ester, as shown in scheme (v) leads to formation of 8-membered rings in the main chain.

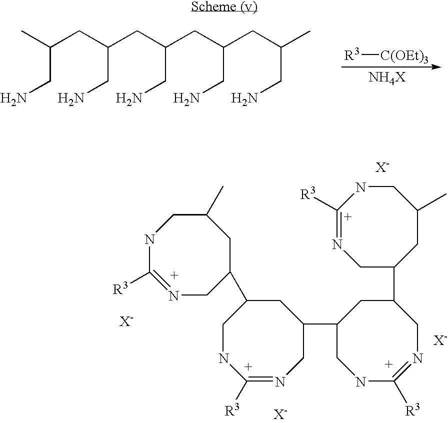

In both schemes, R³ is as defined for structural unit (I).

The anions X⁻ introduced in the synthesis using ortho esters can later be replaced by other desired counterions.

Depending on the type of anion and depending on the molecular weight and structure of the polymer skeleton, the cationic polymers can be in different physical states ranging from liquid via soft, gel-like, vitreous, hard to partially crystalline. The ion density and the type of anions and also the hydrophilicity of the polymer influence, inter alia, the electrical properties, e.g. the ionic conductivity and the specific volume resistance.

The ionic liquid is preferably a salt made up of a cation selected from among imidazolium ions, pyridinium ions, ammonium ions and phosphonium ions of the following structures 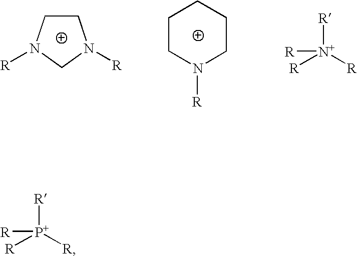
where R and R′ are each, independently of one another, H or an alkyl, olefin or aryl group, or from among substituted and unsubstituted imidazolinium, tetrahydropyrimidinium and tetrahydro-1,3-diazepinium ions and an anion selected from the group consisting of halides, i.e. chloride, bromide and iodide, preferably iodide; phosphate; halophosphates, preferably hexafluorophosphate; alkyl phosphates; nitrate; sulfate; hydrogensulfate; alkyl sulfates, preferably octyl sulfate; aryl sulfates; perfluorinated aryl and alkyl sulfates; sulfonate, alkylsulfonates; arylsulphonates; perfluorinated arylsulfonates and alkylsulfonates, preferably triflate; perchlorate; tetrachloroaluminate; tetrafluoroborate; alkyl borates, preferably B(C₂H₅)₃C₆H₁₃⁻; tosylate; saccharinate; alkyl carboxylates and bis(perfluoroalkylsulfonyl)amide anions, preferably the bis(trifluoromethylsulfonyl)amide anion, or a mixture of a plurality of such salts. Particularly good compatibility with ionic liquids is observed when the latter have not only the same anion as the cationic polymer but the structure of the cations of the ionic liquid also corresponds to the cationic units of the polymer.

Preferred anions for the ionic liquid are iodide, hexafluorophosphate, alkyl sulfates, especially octyl sulfate, tetrafluoroborate and the bis(trifluoromethylsulfonyl)amide anion.

The compositions according to the invention can be prepared using the customary processes known to one skilled in the art. Examples which may be mentioned are:
mechanically mixing the cationic polymer and the ionic liquid, for example by means of an extruder or stirrer, at appropriate temperatures
dissolving the cationic polymer in the ionic liquid, if necessary at elevated temperatures
precipitating the cationic polymer and the ionic liquid from a conjoint solution by means of a nonsolvent or by lowering the temperature
salting the cationic polymer and the ionic liquid out from a conjoint solution
recovering the cationic polymer and the ionic liquid from a conjoint solution by removing the initially included solvent.

The compositions according to the invention possess a high ion conductivity and are easy to process.

The presence of an ionic liquid in the composition according to the invention reduces the intra- and intermolecular interactions between the functional groups of the cationic polymer and hence generally will reduce the viscosity of the cationic polymer. This results in improved processing properties, which is of advantage for many applications or makes some applications possible in the first place. The ionic liquid thus acts as a plasticizer in the cationic polymer. The increased flowability of the melts of the cationic polymer is due to the solventlike character of the ionic liquids, the particular advantage being the non-volatility of the ionic liquids even at the processing temperatures of the composition. As a result it is possible either to use processing temperatures at which the previously used plasticizers or processing aids already have an excessive vapor pressure and lead to outgassing, or to process the cationic polymer at lower temperatures because of the plasticizing effect.

A decisive advantage of the present invention is that the ionic liquid—in contrast to previously known plasticizers—has no negative, or only positive, effects on the conductivity of the cationic polymer in the composition. The electrical properties of the composition according to the invention can be adapted within wide limits through choice of the cations and anions used, whereby antistatic and partly also semi-conducting properties can be created.

Similarly, the adhesion of the composition according to the invention to surfaces which are polar or incipiently swollen or dissolved by the ionic liquid is improved by the presence of the ionic liquid.

The above-recited particular advantages of the compositions according to the invention suggest as a function of their specific properties many different possible uses for the compositions, for example as solid or gel-like polyelectrolytes in batteries and solar cells; in electronic components; as ion-conducting adhesives having adjustable thermal and electrical properties; as coating ingredients having for example a biocidal and/or antistatic effect or an antiblocking effect, for example for natural or synthetic fibers or textile wovens, formed-loop knits, webs, nets or mats composed of natural or synthetic fibers and for foils and films; as coating ingredients for small particles to improve their dispersion and/or their electrophoretic mobility; as solvents having complexing and/or stabilizing effects, for example for catalytic reactions; as separating materials in gas and liquid separation, for example in chromatographic processes for analytical and preparative purposes; as membrane constituents and for optical components having adjustable optical properties (refractive index for example), and also in diverse other optical applications.

The composition according to the invention can also be used as a miscible or self-separating additive for other polymers, for example to modify the viscosity (i.e. as a plasticizer) and/or the conductivity. This permits for example a thermoplastic processing of diverse polymers where thermoplastic processing would otherwise be very difficult or completely impossible, for example aramids, ionomers, polyesters, polyamides and polyether ketones. This makes the polymers in question amenable to thermal methods of processing such as injection molding, fiber spinning, film production or other extrusion processes.

In an embodiment of the invention which has already been mentioned, ionic bonding of the cationic polymer to anions which form liquid crystal phases gives liquid-crystalline polymers in combination with ionic liquids, which make possible simple production of thin layers and the adjustment of their optical and thermal properties.

1. A composition comprising
a cationic polymer having cyclic nonaromatic units which comprise an amidinium group and
an ionic liquid.

2. The composition as claimed in claim 1, wherein the cyclic nonaromatic units which comprise an amidinium group are substituted or unsubstituted 5-, 6- or 7-membered rings or combinations thereof.

3. The composition as claimed in claim 2, wherein the cyclic nonaromatic units which comprise an amidinium group are selected from the group consisting of substituted and unsubstituted imidazolinium, tetrahydropyrimidinium group, tetrahydro-1,3-diazepinium group and combinations thereof.

4. The composition as claimed in claim 2, wherein the cyclic nonaromatic units which comprise an amidinium group are located in the main chain of the polymer and are linked to the main chain via C or N atoms of the cyclic nonaromatic units.

5. The composition as claimed in claim 4, wherein the cationic polymer comprises the following structural unit in the main chain: 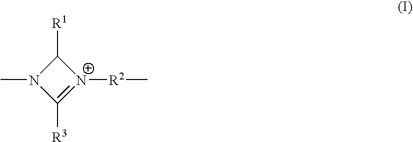
wherein R¹ is —(CH₂)ₙ— wherein n=2, 3 or 4;
R² is —(CH₂)ₘ— wherein 0<m<22,
—CH═CH—CH₂—,
—CH═CH—CH₂—CH₂—,
—CH═CH—,
—CH═CH—CH═CH—,
a monocyclic or polycyclic arylene radical or
a divalent polyether radical of the structure —(CH₂)ₖ—(O—(CH₂)ₖ)ₚ— wherein 0<k<22 and 0<p<100,; and
R³ is —(CH₂)₁—CH₃ wherein 0<1<21 or
a monocyclic or polycyclic aryl radical.

6. The composition as claimed in claim 5, wherein n=2 and R²═R¹ and the cationic polymer is prepared from essentially linear polyethylenaamine.

7. The composition as claimed in claim 3, wherein the cyclic nonaromatic units which comprise an amidinium group are located in the side chains of the polymer and said side chains comprise one of the following structures: 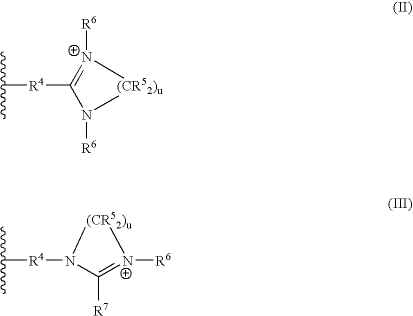
wherein u=2, 3 or 4;
R⁴ is selected from the group consisting of
—(CH₂)ᵣ— wherein 0<r<22,
—(CH₂)ₛ—(O—(CH₂))ₛₜ— wherein 0<s<22 and 0<t<100 and
—CO—Y—(CH₂)ᵤ— wherein Y═O or NH and 1<u<23;
R⁵ is selected from the group consisting of H, —CH₃, —C₂H₅, —C₃H₇ and —C₄H₉ and may be identical or different within a unit;
R⁶ is an unbranched or branched alkyl radical having from 1 to 18 carbon atoms and may be identical or different within a unit;
and R⁷ is H or R⁶.

8. The composition as claimed in claim 1, wherein the counterion of the cationic polymer is selected from the group consisting of halide, phosphate, halophosphates, alkyl phosphates, nitrate, sulfate, hydrogensulfate, alkyl sulfates, aryl sulfates, perfluorinated alkyl and aryl sulfates, sulfonate, alkylsulfonates, aryl-sulfonates, perfluorinated alkylsulfonates and arylsulfonates, perchlorate, tetrachloroaluminate, tetrafluoroborate, alkyl borates, tosylate, saccharinate, alkyl carboxylates, bis(perfluoro-alkylsulfonyl)amide anions and mixtures thereof.

9. The composition as claimed in claim 8 wherein the counterion of the cationic polymer is a halide and the halide is an iodide.

10. The composition as claimed in claim 1, wherein the counterion of the cationic polymer is an ion capable of producing liquid-crystalline states.

11. The composition as claimed in claim 1, wherein the ionic liquid is a salt comprising a cation selected from the group consisting of
imidazolium ions, pyridinium ions, ammonium ions, phosphonium ions as represented by the following structures: 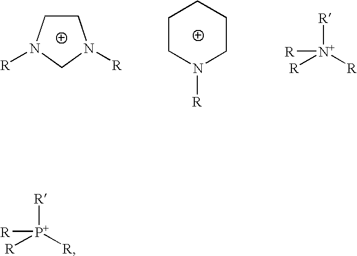
substituted or unsubstituted imidazolinium ions,
tetrahydro-pyrimidinium ions and
tetrahydro-1,3-diazepinium ions,
wherein R and R′ are each independently H, an alkyl, an olefin or an aryl group;
and an anion selected from the group consisting of halide, phosphate, halophosphates, alkyl phosphates, nitrate, sulfate, hydrogensulfate, alkyl sulfates, aryl sulfates, perfluorinated alkyl and aryl sulfates, sulfonate, alkylsulfonates, arylsulphonates, perfluorinated alkylsulfonates and arylsulfonates, perchlorate, tetrachloroaluminate, tetrafluoroborate, alkyl borates, tosylate, saccharinate, alkyl carboxylates and bis(per-fluoroalkylsulfonyl)amide anions;
or mixtures thereof.

12-14. (canceled)

15. A polyelectrolyte comprising the composition as claimed in claim 1, wherein the polyelectrolyte is comprised in batteries or solar cells.

16. An additive for polymers comprising the composition as claimed in claim 1.

17. An optical component comprising the composition as claimed in claim 1.
